(19) United States
(12) Patent Application Publication
(10) Pub. No.: US 2004/0096164 A1
(43) Pub. Date: May 20, 2004

(54) Optical signal transmission system

(76) Inventors: Joachim Guttmann, Ulm (DE); Hans-Peter Huber, Neu-Ulm (DE); Oskar Krumpholz, Ulm (DE); Joerg Moise, Neu-Ulm (DE); Manfred Rode, Senden (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/399,938

(22) PCT Filed: Oct. 25, 2001
(86) PCT No.: PCT/EP01/12355

(30) Foreign Application Priority Data
Oct. 28, 2000 (DE) 10053670.0

(51) Int. Cl. G02B 6/42

(52) U.S. Cl. 385/88

(57) ABSTRACT

The invention relates to an optical signal transmission system for transmitting data between electronic units via a rear plate. The inventive transmission system comprises a point of separation on which an optical image system (31), for an easily separable connection, is arranged in such a way that optical power loss during the signal transmission is minimised.

The present invention relates to an optical signal transmission system according to the definition of the species in claim 1.

Single-mode fiber-optic lines have been used in the field of telecommunication for some time. For short distances, within computer housings for example, these technologies known from telecommunication are too complex and too expensive.

A signal transmission system suitable for short transmission distances is described in German Patent 44 34 727 C1 for example. It includes a light-conducting glass plate as a rear panel and electronic modules which are perpendicularly located thereto and are positioned on the rear panel via plug-in connections. Electro-optical transmission units are integrated in the connector, emitting and receiving light beams which hit the rear panel perpendicularly. The transmission units are connected to the appropriate electronic module via flexible electric lines. Light beams hitting the rear panel are deflected at a suitable angle via couplers and are guided within the light-conducting glass plate using total reflection. The electro-optical transmission units are connected to the electronic modules as stand-alone submodules via flexible mounts, for example. These vibratingly supported mounts make it possible to align the submodules within certain tolerance limits independently from the position of the module with regard to the rear panel.

Furthermore, a signal connection device is described in German Patent Application 40 03 056 A1 in which the signal exchange between a transmitter and a receiver takes place via an optical waveguide which is integrated into a rear panel composed of several layers. The signal is transmitted to the optical waveguide via imaging optics. The optical waveguide is situated on or in the rear panel, intended for conducting the light, either on the entire surface or, for example, in a strip pattern only in some areas. Light transmission takes place with the aid of couplers as an additional measure for beam formation in order to keep coupling losses small at the coupling and decoupling points between the optical waveguide and the optical transmitter or receiver.

In transmission systems described in the related art, the plug-in modules are flexibly positioned via plug-in connections in order to adjust tolerances at the separation points. Such flexible mounts are for the most part technologically complex and expensive. However, an accurate adjustment of the modules with regard to the rear panel, without additional devices, cannot be accomplished without optical power losses. This is the case in particular when light is injected into strip-shaped or fiber-shaped waveguides. Even the slightest assembly inaccuracies or tippings, which multiply after repeated reflection, may result in no more light transmission taking place to the injection point.

The present invention is based upon the object of providing a simple signal transmission system for the coupling of electronic modules with the rear panel with tolerances as high as possible with regard to misadjustment.

The features of claim 1 represent the present invention. The subclaims include advantageous embodiments and refinements of the present invention.

The present invention comprises an optical signal transmission system for transmitting data between electronic modules via a rear panel. It is particularly suitable for easily detachable plug-in connections. The transmission system is composed of the optical elements of a transmitter, an optical waveguide, having a preferably fiber-shaped design, and a receiver, as well as a separation point at which an optical imaging system for the easily detachable connection is situated. The acceptance surface of the optical element for the injection of light is situated on the image side of the imaging system; the injection of light is determined, for example, by the waveguide cross section or by the light-sensitive surface of a receiving diode. The acceptance angle is similarly determined, for example, by the numerical aperture of the waveguide. The acceptance surface, the acceptance angle, or both are enlarged with respect to the object side by an amount which is determined by the positioning tolerance of the misadjustment of the separation point. The enlargement has the purpose of minimizing optical power losses.

Multi-mode waveguides offer the possibility of selecting the numerical aperture and the waveguide cross section independently from one another. If the numerical aperture and the cross section are selected appropriately, light losses by aberration due to imperfect optical imaging systems may also be prevented. Accordingly, depending on the positioning tolerance, either the waveguide cross section or the numerical aperture is increased at each transition of a separation point.

For example, a photodiode, used as a receiver in combination with a waveguide whose cross section is 30% to 70% of the active photodiode surface, is situated on the image side as part of the optical imaging system. An MSM (metal-semiconductor-metal) photodiode is preferably used here.

The optical imaging system for the transmission of signals between the modules of the rear panel preferably includes, on the object side, a laser diode having a vertical resonator.

Advantageously, no power losses occur at all in the event of assembly inaccuracies with regard to a lateral displacement or tipping of the components against each other. This has an advantageous effect in multi-mode waveguides in which the numerical aperture and the waveguide cross section may be selected independently from one another.

In the following, the present invention is explained in greater detail with reference to the schematic drawing.

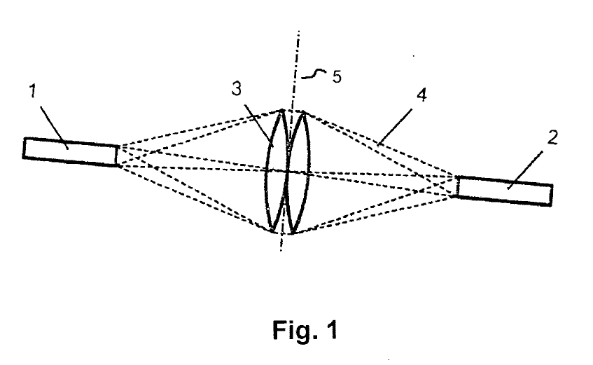

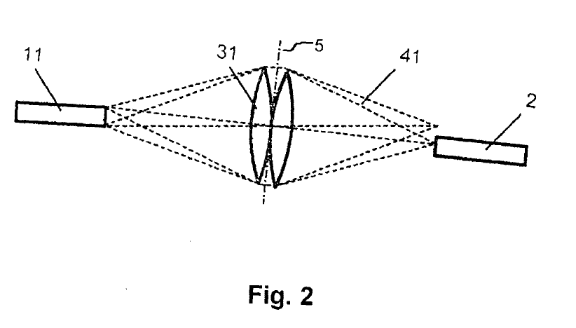

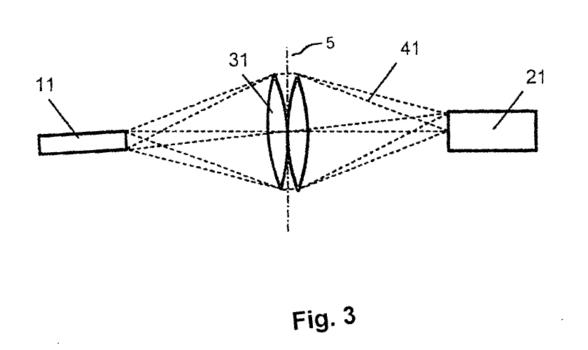

FIG. 1a) shows a schematic diagram of an ideal imaging system,

FIG. 1b) shows a schematic diagram of a tipped imaging system,

FIG. 1c) shows a schematic diagram of the system according to the present invention.

A first exemplary embodiment according to FIG. 1 shows in which way the signal is optically transmitted at the separation points, via lenses for example. Light 4 propagates from a waveguide 1 or a transmitter and is projected via a lens system 3 into a receiver or into an additional optical waveguide 2. In the ideal case illustrated, without beam expansion or lateral offset, the light beam is projected accurately onto the receiver, from the transmitter via the optical waveguide. FIG. 1b shows the effects on beam path 41 of a tipped waveguide 11 and an incorrectly adjusted lens 31. The light beam, hitting the optical waveguide on the image side, is laterally deflected and no longer completely hits its acceptance surface. Part of the optical power is thereby lost. The system according to the present invention, shown in FIG. 1c, explains how the light, via inevitable misadjustment, may be guided without losses on the image side. Optical waveguide 21, with its diameter enlarged, is exactly dimensioned such that, within the limits of the misadjustment, the laterally offset beam still hits the acceptance surface completely.

This ensures that the light is injected in and decoupled from the optical waveguide, always incurring minimal optical power losses.

A specific embodiment of an optical backplane is based on a laser diode having a round emitting surface of approximately 10 μm in diameter and a numerical aperture of 0.1. At the first separation point, the light is projected onto a waveguide having the dimensions of 200 μm×200 μm and the numerical aperture of 0.3. At the second separation point, the light from the waveguide hits a round photodiode having a diameter of 400 μm and with an angle of approximately 60° (equal to a numerical aperture of approximately 0.8).

What is claimed is:

1. An optical signal transmission system comprising the optical elements of a transmitter, optical waveguides (11, 21), and a receiver, as well as at least one separation point at which an optical imaging system for an easily detachable connection is situated, wherein, on the image side of the imaging system, the acceptance surface of the optical element and/or the acceptance angle of the optical element are increased with respect to the object side by an amount which is determined by the positioning tolerance of the separation point, in order to minimize optical power losses.

2. The signal transmission system as recited in claim 1, wherein the receiver on the image side is a photodiode, and the waveguide cross section on the object side is 30% to 70% of the active photodiode surface.

3. The signal transmission system as recited in claim 2, wherein the receiver is an MSM diode.

4. The signal transmission system as recited in claims 1, 2, or 3, wherein the transmitter on the image side is a laser diode having a vertical resonator.
